(19) United States
(12) Patent Application Publication
(10) Pub. No.: US 2015/0335526 A1
(43) Pub. Date: Nov. 26, 2015

(54) Handling Useful Sauna Equipment

(71) Applicant: Seung Woo LEE, Yorba Linda, CA (US)

(72) Inventor: Seung Woo LEE, Yorba Linda, CA (US)

(21) Appl. No.: 14/284,185

(22) Filed: May 21, 2014

(51) Int. Cl. A61H 33/06

(52) U.S. Cl. CPC A61H 33/06; A61H 33/063; A61H 2033/061

(57) ABSTRACT

The invention is to provide a knee sauna device, in which delays or minimizes heat loss by adjusting according to a lower body condition of user and making it contact tightly to thighs, enabling to enjoy a dry-type sauna, which includes a case (10) having a opening portion (11), a raising board (20) installed in the opening portion (11) of the case (10) so as to be raised or lowered, a stopper (30) installed between the case (10) and the raising board (20) and fixing the raising board (20), a first heater (40) installed on an internal bottom surface of the case (10), and a second heater (50) installed on an internal top surface of the case (10) protrudingly toward the opening portion (11). The raising board enables a user to adjust and use according to lower body condition (knee height and thigh thickness).

### FIELD OF THE INVENTION

The present invention relates to a handling useful sauna equipment. More particularly, this invention relates to a very convenient handling useful sauna equipment, which receives a lower body (knee) inside and enables a user to enjoy a dry sauna through a heat source.

### BACKGROUND OF THE INVENTION

In general, it has been well known that it is essential for health and fast recovery from fatigue to keep the feet warm according to the physiology of human body, and the Korean medicine or acupuncture testifies that since all the nerve system of the body are connected to the feet the metabolism of the whole human body can be facilitated by warming the feet, and therefore, foot bath devices and knee sauna devices of many types and functions have been developed for warming the feet.

Thus many kinds of sauna machines have been used widely, which massage the feet by stimulating the feet artificially using various kinds of devices or expect sauna effects by warming the feet in a predetermined temperature.

Among these, almost all of them are wet-type feet sauna machines in which the feet must be immersed in warm water heated to a predetermined temperature, but it is inconvenient that they require to take heed so as not to shed water around the place and to clean and discard the used water as well as limit bodily activity and the usage to a limited space.

And, in the conventional feet sauna machines, the structure was complicated due to a heating device for heating water, the electrical energy consumption was large due to the necessity of keeping to heat, and it was not convenient to handle or move around because they were voluminous.

Therefore, recently dry-type feet sauna machines have been used widely, such as one disclosed in the Korean Utility Patent Application No. 20-410307 (titled “Feet Sauna Machine for Red Clay Bath).

However, such conventional technologies have disadvantages that since heated air escape easily the thermal loss was large, and since they work mainly on the feet they were not so effective for people who have cold or painful knees.

### PROBLEMS TO SOLVE

The invention regards to improving the above conventional technologies, and is to provide a handling-useful knee sauna equipment, which delays or minimize discharging of internal heat source by adjusting the height of knees and so as to contact the thighs as tightly as possible 0 at the body dimension of user, such that the user can enjoy the dry-type sauna.

### SOLUTIONS TO PROBLEMS

The invention provides a handling useful sauna equipment comprising: a case having an opening; a raising board installed in the opening so as to be raised or lowered; a stopper installed between the case and the raising board and configured for fixing the raising board; a first heater installed on an internal floor surface of the case and configured for receiving electricity and generating heat; and a second heater installed so as to protrude toward the opening from an internal top surface of the case and configured for receiving electricity and generating heat.

Also, in the present invention, a top end portion of the case may protrude outside further.

Also, in the present invention, to a top side of the case may be inserted slidably an extension board.

Also, in the present invention, in a top end portion of the case may be installed rotatably an L-shaped cover.

Also, in the present invention, the stopper may comprise: a fixing device including a body installed inside on a surface of the case that faces together with a side surface of the raising board; a ball received in the body, and a spring installed between the ball and the body and engaging elastically against a side surface of the raising board; and a rail formed repeatedly in a direction of length and installed an a side surface of the raising board with fixing grooves in which the ball is being received.

### EFFECTS OF INVENTION

According to an embodiment of the invention, the equipment is very convenient to use and delays maximally or minimizes discharging of internal heat because it can be used irrespective of bodily condition such as a user's lower body shape (knee height and thigh thickness) through the raising board installed in the case so as to be raised or lowered.

Also, the case may be formed so that the top portion thereof protrude or an extension board be installed slidably. Then since the extension board can be pulled toward the user so that the extension board is to be contacted tightly to a top portion of the user's thighs, the interval between the extension and the thighs can be minimized, and it can be used flexibly even to different conditions of the user's lower body condition (thick or thin thighs). Furthermore, since the protruding portion works as a duct when the internal heat escapes to outside after passing the user's thighs maximally it enables to manage the heat loss more efficiently, and further since the user can perform other works along with the sauna with a drink, a notebook, a book, etc. disposed in the extended surface, its usage is very convenient and useful.

Furthermore, a cover rotating on a hinge may be installed on a top portion of the case so as to be able to enlarge the space of opening when the cover rotates, and thus the user may be able to have the lower body received in or escaping from the inside of the case.

### BRIEF DESCRIPTION OF DRAWINGS

FIG. 1 is a perspective rear view showing a first embodiment of a knee sauna device 0 at the invention.

FIG. 2 is a rear view of FIG. 1.

FIG. 3 is a side cross-sectional view along A-A in FIG. 1.

FIG. 4 is a cross-sectional view showing a heater extracted from the first embodiment of the knee sauna 0 at the invention.

FIG. 5 is an enlarged view showing a part of FIG. 4.

FIG. 6 is a cross-sectional view along C-C in FIG. 4.

FIG. 7 is a diagram for describing an operation of a heater.

FIG. 8 is a perspective rear view showing a second embodiment of a knee sauna device 0 at the invention.

FIG. 9 is a side cross-sectional view along D-D in FIG. 8.

FIG. 10 is a perspective rear view showing a third embodiment of a knee sauna device 0 at the invention.

FIG. 11 is a side cross-sectional view along E-E in FIG. 10.

FIG. 12 is a perspective rear view showing a fourth embodiment of a knee sauna device 0 at the invention.

FIG. 13 is a side cross-sectional view along F-F in FIG. 12.

### DETAILED DESCRIPTION OF EMBODIMENTS OF INVENTION

Below, the invention is going to be described in detail referring to the Drawings.

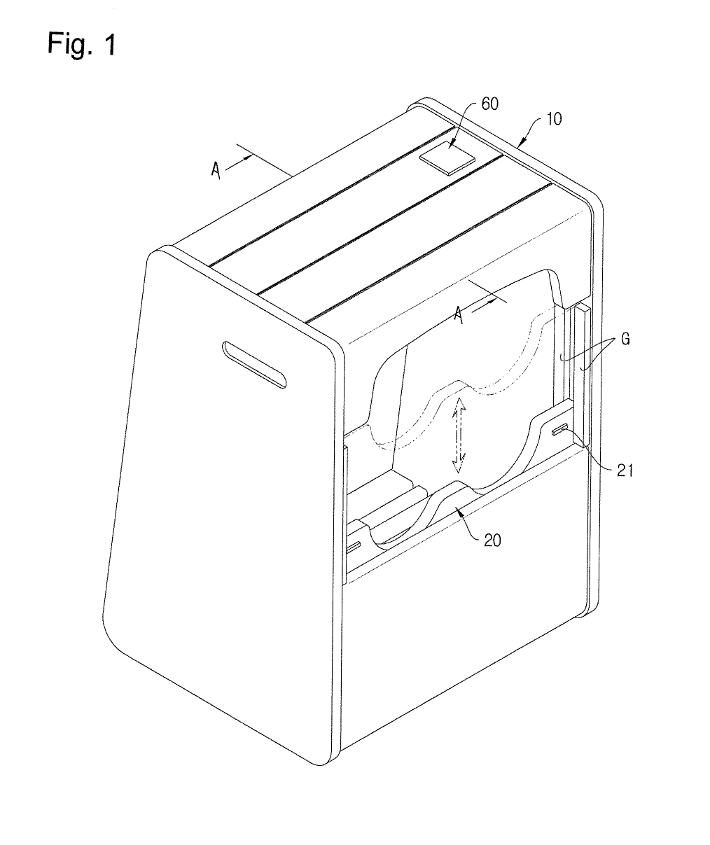

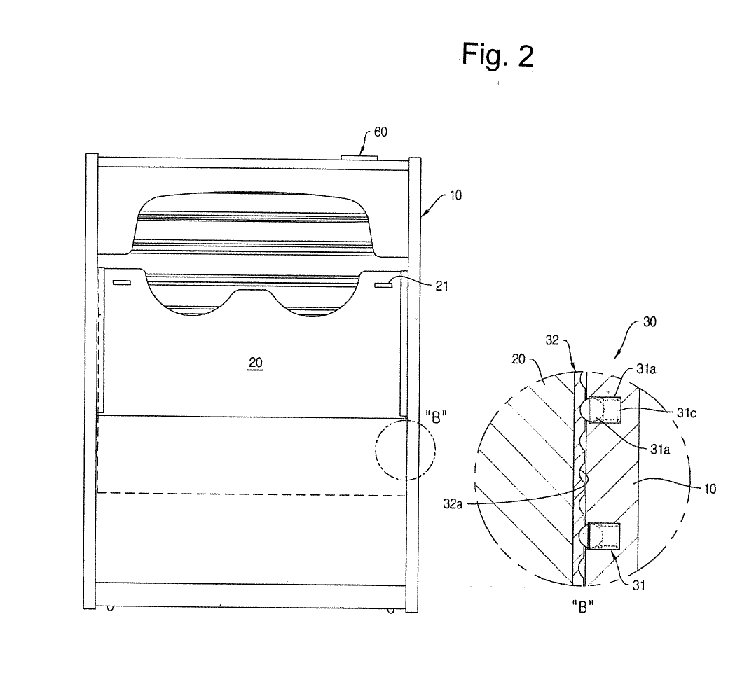

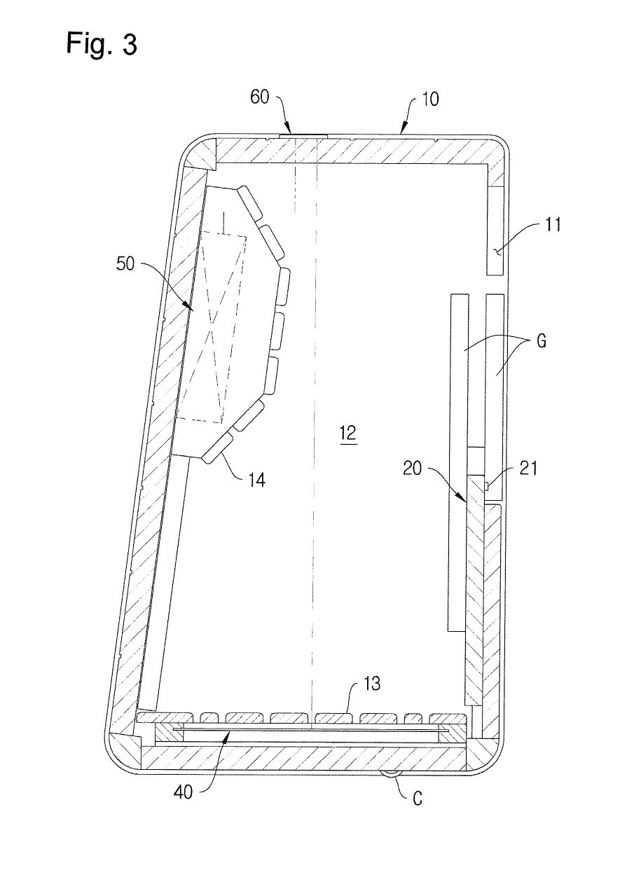

FIG. 1 is a perspective rear view showing a first embodiment of a knee sauna device 0 at the invention, FIG. 2 is a rear view of FIG. 1, and FIG. 3 is a side cross-sectional view along A-A in FIG. 1.

Referring to FIGS. 1 to 3, a knee sauna 0 at a preferable first embodiment of the invention includes a case (10), a raising board (20), a stopper (30), a first heater (40), and a second heater (50), and is configured for enjoying a dry-type sauna through heat sources of the first heater (40) and the second heater (50) with feet received in the case (10).

Referring to FIGS. 1 to 3, the case (10) has a shape of box, and in this embodiment a plurality of plates (front, rear, left, right, top, bottom, etc.) are assembled into a box shape through fastening means (screw bolt).

And, the case (10) includes an opening portion (11), a receiving portion (12) provided inside for receiving user's feet inserted through the opening portion (11), a foot board (13) installed on an internal bottom surface thereof, a heater cover (14) installed on an internal front surface thereof, and a guide portion (G) installed with intervals on the internal side surface where the opening portion (11) is installed.

Here, the foot board (13) performs a function of fixing the stopper (30) and isolating the user's foot soles from the stopper (30) so that they don't touch each other, and the heater cover (14) performs a function of enclosing and protecting the first heater (40) and isolating the user's knees from the first heater (40) so that they don't touch each other, and the guide portion (G) performs a function of guiding and supporting so that the raising board (20) moves up and down only.

Especially, in the foot board (13) and the heater cover (14), a gap for heat discharging may be provided preferably so that the heat generated by the stopper (30) and the first heater (40) can be delivered to the receiving portion (12).

On the other hand, on a bottom surface of the case (10) are provided castors (C; refer to FIG. 3), enabling to move around through them.

Referring to FIGS. 1 to 3, the raising board (20) is inserted in the guide portion (G) formed in the opening portion (11) of the case (10), so as to adjust a height thereof 0 at the user's lower body (height from sole to knee), contacts a bottom surface of the thighs maximally, minimizing the heat in the case (10) escaping to outside.

As an example, conditions of lower bodies (height from sole to knee) depend on users, and for a user with a long lower body the heat loss to the outside due to the interval between the rear board and the thighs can compromise enjoying of the dry-type sauna.

Thus, 0 at the embodiment, by adjusting the height of the raising board (20) flexibly a0t such lower body conditions (height from sole to knee) of the user, making a tight contact to the bottom surface of the thighs, and removing the intervals between the rear board and the thighs, the problem of losing internal heat to outside can be solved, making the dry-type sauna enjoyable.

And, on a surface of the raising board (20) is provided a handle (21) protruding outwards, and the user can adjust the height of the raising board (20) using the handle (21) conveniently while sitting.

Referring to FIG. 2, the stopper (30) includes a fixing device (31) and a rail (32), and in the embodiment it is installed between the case (10) and the raising board (20) and fixes the raising board (20) that is raised or lowered.

As shown in “B” of FIG. 2, the fixing device (31)s are installed in pairs on a side surface of the case (10), and preferably another pairs of them may be installed on a side surface of the opposite case (10).

The fixing device (31) includes a ball (31a) installed inside of the case (10) facing a side surface of the raising board (20), a ball (31b) received in the ball (31a), and a spring (31c) installed between the ball (31b) and the ball (31a) and engaging the ball (31a) elastically against a side surface of the raising board (20), and performs a function of fixing the raising board (20) where the rail (32) is installed.

The rail (32) is a plate of a constant width and length with fixing groove (32a)s formed repeatedly in a length direction, and in the embodiment it is installed on both side surfaces of the raising board (20) and limited to move up and down by the ball (31a) inserted in the fixing groove (32a).

According to the embodiment, the raising board (20) can be fixed stably at a position where the user desires through the fixing device (31) and the rail (32).

Referring to FIG. 3, the first heater (40) is a surface-type heat-generating body, and in the embodiment it is installed in the foot board (13), receives electricity, and generates heat.

The first heater (40), that is, the surface-type heat-generating body, is well known in the field, and detailed description is omitted.

Referring to FIG. 3, the second heater (50) is a surface-type heat-generating body or a sheath heater, and in the embodiment, it is installed so as to protrude toward the opening portion (11) from an internal top surface of the case (10), and generates heat with electricity supplied.

The second heater (50) is enclosed by the heater cover (14) and protected so as not to touch the user's knees.

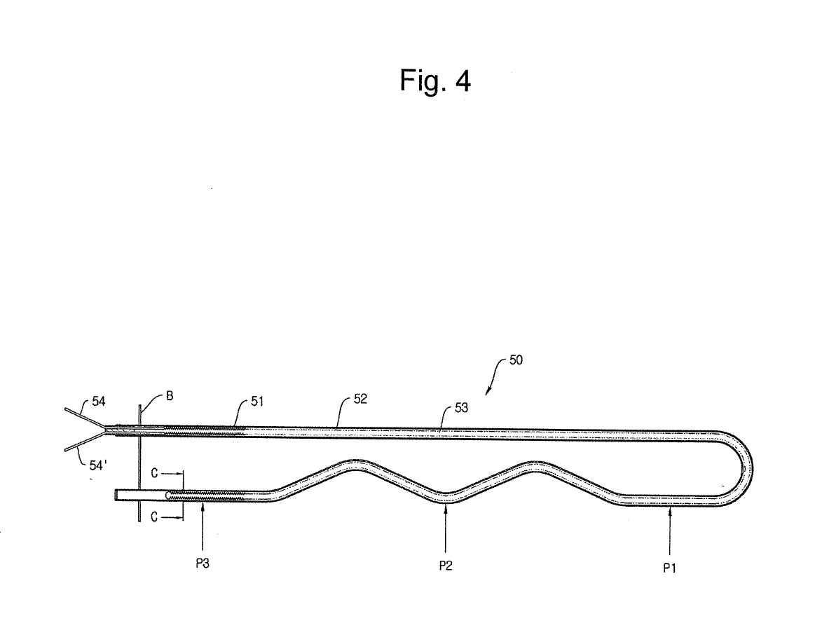

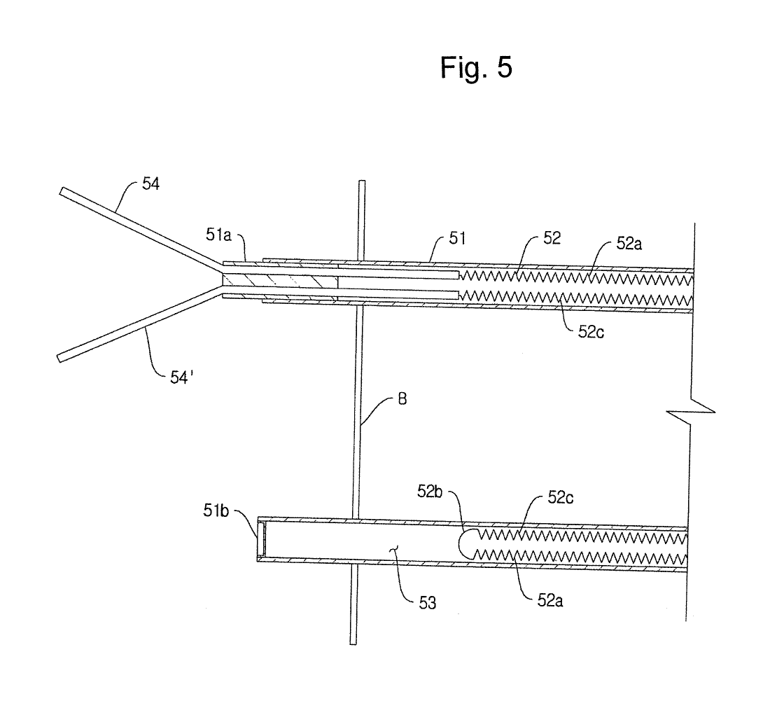

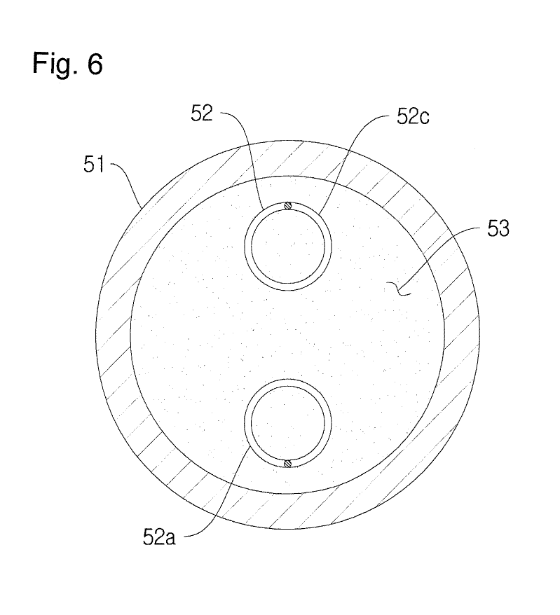

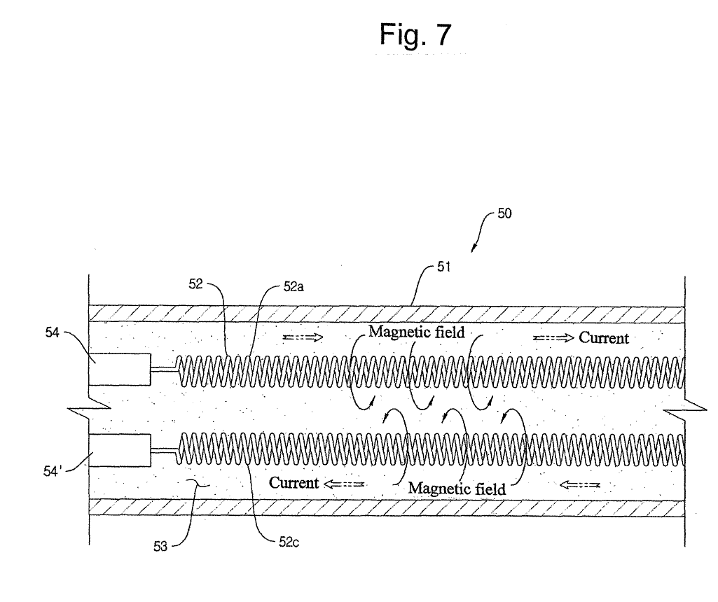

FIGS. 4 through 7 show the second heater (50) taken out separately, and FIG. 4 is a cross-sectional view showing a heater extracted from the first embodiment of the knee sauna 0 at the invention, FIG. 5 is an enlarged view showing a part of FIG. 4, FIG. 6 is a cross-sectional view along C-C in FIG. 4, and FIG. 7 is a diagram for describing an operation of a heater.

The second heater (50) comprises a metal tube (51), a heating wire (52), a insulating powder (53), and terminals (54, 54′).

The metal tube (51), heating wire (52), insulating powder (53), and terminals (54, 54′) are same as those of the conventional sheath heater. But, what should be noted is the heating wire (52) installed in the metal tube (51), more specifically, that they are disposed with an interval so as not to touch each other and installed so that the ends at one side are connected to each other and the terminals (54, 54′) connected to the ends are exposed to any one of both ends of the metal tube (51).

According to the above structures, additional effects can be expected, which include that the magnetic field (electro-magnetic wave) can be reduced drastically because a destructive interference of the magnetic field (electro-magnetic wave) by making directions of currents opposite to each other, furthermore, since the heating wire (52) is inserted doubly in the metal tube (51) the thermal efficiency can be maintained as before and at the same time the length of the metal tube (51) can be reduced much due to the short length of the heating wire (52) enabling to reduce the fabricating cost and to make in a small size, so that the installation space can be reduced and the size of the applied heaters can be reduced.

Referring to FIGS. 4 to 6, the metal tube (51) is a tube with both ends opened and the inside penetrated.

On both ends of the metal tube (51) are installed a terminal-fixing cap (51a) and a plug (51b) respectively.

Here, the terminal-fixing cap (51a) blocks one end of the metal tube (51) and fixes the terminals (54, 54′), and the plug (51b) blocks the other end of the metal tube (51) lest the insulating powder (53) filled inside the metal tube (51) be spilled out.

And, for the terminal-fixing cap (51a) is preferably used an insulator such as a hard porcelain and the like for insulating the metal tube (51) and each of the terminals (54, 54′).

Also, if necessary, the metal tube (51) may be fabricated in a shape as shown in FIG. 4, and are fixed with a bracket (B) inserted inbetween in order to maintain both ends separated from each other.

By the way, the bracket (B) is fixed on an internal wall surface of the case (10).

On the other hand, on an outer surface of the metal tube (51) may be painted far-infrared-emitting material.

Here, the far-infrared-emitting material may be one selected from a group consisting of tourmaline, red clay, rock salt, germanium, elvan, jade, charcoal, and ceramic powder, and in the embodiment, it is painted on an outer surface of the metal tube (51).

Especially, since the far-infrared-emitting material usually has some brittleness, they had better be painted after the metal tube (51) is formed.

The heating wire (52) is an electrical heating body that generates heat through resistance when current flows, and in the embodiment, it is installed in the metal tube (51).

It should be noted here that the heating wire (52) is installed in the metal tube (51), more specifically, they are disposed with an interval so as not to touch each other and installed so that the ends at one side are connected to each other and the terminals (54, 54′) connected to the ends are exposed to any one of both ends of the metal tube (51).

In this embodiment, as the heating wire (52) is used a nichrome wire that has a high resistance and a high anti-oxidation at a high temperature, and additionally iron-chrome wire, tungsten, platinum, etc. may be applied.

On the other hand, if current flows through the heating wire (52), a magnetic field (electro-magnetic wave) is generated from the heating wire (52), and if exposed to such magnetic field (electro-magnetic wave) for a given time, it may affect badly to a human body.

However, 0 at the embodiment, since the heating wire (52) is disposed in the metal tube (51) so that the directions of the heating wire (52) are opposite to each other, the generated magnetic fields (electro-magnetic waves) act in opposite directions and can interfere each other destructively, reducing the magnetic field (electro-magnetic wave) drastically, and therefore even though they are used in the knee sauna 0 at the invention, the effect to the human body gets as feeble or ignorable as of 3 mG, and they can be used very safely even in a structure of the knee sauna 0 at the invention, in which the lower body (knees and feet) should be put closely.

Furthermore, since the heating wire (52) is inserted doubly in the metal tube (51) the thermal efficiency can be maintained as before and at the same time the length of the metal tube (51) can be reduced much due to the short length of the heating wire (52) enabling to reduce the fabricating cost and to make in a small size, so that the installation space can be reduced and the size of the applied heaters can be reduced.

The insulating powder (53) is for insulating the metal tube (51), the heating wire (52), and the raising board (20) separated from each other with intervals and increasing thermal conductivity, and in the embodiment, MgO is used for it, and of course, if performing equivalent functions any well-known material can be applied.

According to the embodiment, by filling and pressurizing the insulating powder (53) between the metal tube (51) and the heating wire (52), it is possible to make it solid against external physical shock and to increase the thermal efficiency.

The terminals (54, 54′) are welded and fixed to each end of the heating wire (52). Here, the terminals (54, 54′) penetrate the hole through the terminal-fixing cap (51a) and are exposed outside.

Referring to FIG. 7, the operation of the second heater (50) of the above structure is going to be described below.

If an electrical power is applied to the terminals (54, 54′) by operating a controller (60) installed in the case (10), the current flows through the metal tube (51)2a forming the heating wire (52), a returning portion (52b), and then a second electrical heating portion (52c).

And, in this process, in the first electrical heating portion (52a) and the second electrical heating portion (52c) through which currents flow are generated magnetic fields (electro-magnetic waves) having opposite directions.

More specifically, according to the Ampere's law, the magnetic field (electro-magnetic wave) from the first electrical heating portion (52a) is counterclockwise, and the magnetic field (electro-magnetic wave) from the second electrical heating portion (52c) is clockwise, so that mutually destructive interference may be expected, reducing the magnetic fields (electro-magnetic waves) drastically.

Therefore, in cases that the second heater (50) as in the above is applied to a knee sauna according to the invention, the magnetic fields (electro-magnetic waves) have little effects (less than 2 mG), so that it can be used safely at home with infants or young children in growing period.

Furthermore, since the heating wire (52) is inserted doubly in the metal tube (51) the thermal efficiency can be maintained as before and at the same time the length of the metal tube (51) can be reduced much due to the short length of the heating wire (52) enabling to reduce the fabricating cost and to make in a small size, so that the installation space can be reduced and the size of the applied heaters can be reduced.

The table below is a result of experiment for comparing a conventional sheath heater and the second heater (50; sheath heater) applied to a knee sauna 0 at the invention, and the experiment was performed as follows.

As shown in FIG. 4, setting a first measuring point (P1), a second measuring point (P2), and a third measuring point (P3), of the second heater (50) as in the above, the magnetic fields (electro-magnetic waves) were measured at points distant from the first through the third measuring points (P1, P2, P3) by given distances (25 mm, 50 mm, 75 mm, 100 mm).

Then, 1390 EMF Tester model of a Taiwanese company TES was used for a measuring device, and the unit is mG.

TABLE 1
2^{nd} heater (sheath heater) of Invention/conventional sheath heater

| | P1 | P2 | P3 |
|---|---|---|---|
| 25 mm | 3.1 mG/22.10 mG | 1.8 mG/23.70 mG | 1.9 mG/21.40 mG |
| 50 mm | 1.3 mG/15.80 mG | 0.4 mG/12.90 mG | 0.6 mG/12.60 mG |
| 75 mm | 0.5 MG/9.40 mG | 0.6 mG/8.70 mG | 0.9 mG/7.70 mG |
| 100 mm | 0.5 MG/8.90 mG | 0.9 mG/6.10 mG | 0.7 mG/5.40 mG |

According to the measurement, the second heater (50; sheath heater) applied to the knee sauna 0 at the invention satisfies the environmental criteria (less than 2 mG) from the distance of 50 mm, showing about 81.3% reduction of electro-magnetic wave with respect to the conventional sheath heater, and accordingly if applied to the knee sauna of the invention, the effect of the electro-magnetic wave on the human body is ignorable, enabling a safe usage.

Referring to FIGS. 1 through 3, the controller (60) controls the operation of the first heater (40) and the second heater (50), and in the embodiment, it was installed on a top surface of the case (10) for a convenient control.

The usage of the knee sauna 0 at the first embodiment of the invention as in the above is going to be described below.

First, while a plug (not shown) provided in the case (10) for electrical power is connected to a concent (not shown), the user sits on the chair, inserts the lower body (feet and knees) in the receiving portion (12) through the opening portion (11) of the case (10), and has the soles put on the foot board (13) where the first heater (40) is and has the knees come near to the heater cover (14) where the second heater (50) is.

As in the above, while the lower body is received in the case (10), the user may move the raising board (20) using the handle (21) of the raising board (20) so that the top surface of the raising board (20) contacts tightly the bottom of the user's thighs.

At this moment, the raising board (20) is raised or lowered through segmental movements, and more specifically, if the raising board (20) installed with rail (32) is raised slowly, the ball (31b) of the fixing device (31) inserted in the fixing groove (32a) of the rail (32) pushes the spring (31c) and is inserted into the inside of the ball (31a), and if the next fixing groove (32a) of the rail (32) comes to the position of the previous fixing groove (32a), the ball (31b) is pushed elastically by the spring (31c) and inserted into the fixing groove (32a) and fixes the raising board (20), which happens repeatedly until the user moves the raising board (20) to a desirable position (where the top surface of the raising board (20) contacts the user's thighs tightly).

As in the above, since the ball (31a) of the fixing device (31) is inserted in the fixing groove (32a) of the rail (32) installed on both side surfaces of the raising board (20) even though the raising board (20) is raised upto the user's thighs, the raising board (20) does not fall down but can maintain the present state.

And, the user controls the operation of the first heater (40) and the second heater (50) by controlling the controller (60) disposed on the top surface of the case (10), and the first heater (40) and the second heater (50) controlled by the controller (60) receive electrical power and generate heat, and the heat is introduced into inside of the receiving portion (12) through the foot board (13) and the heater cover (14), enabling the user enjoy a dry-type sauna through the heat.

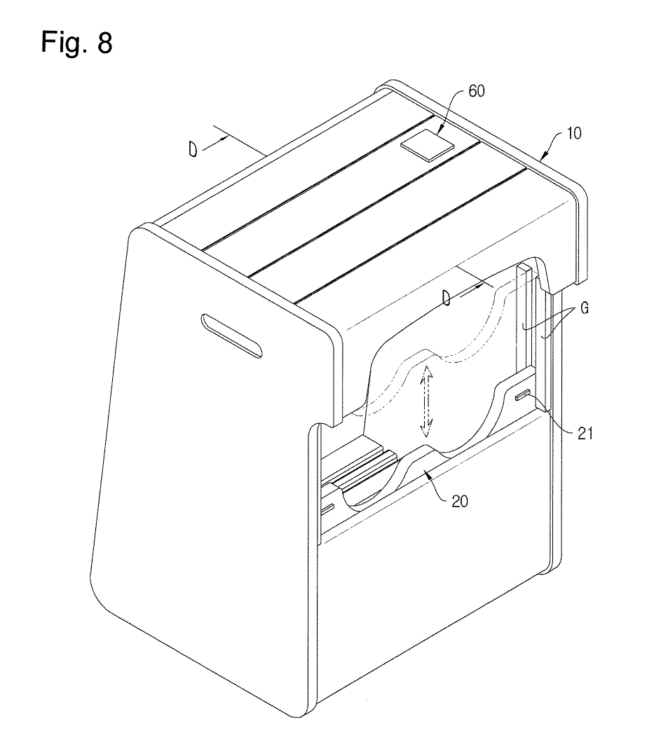

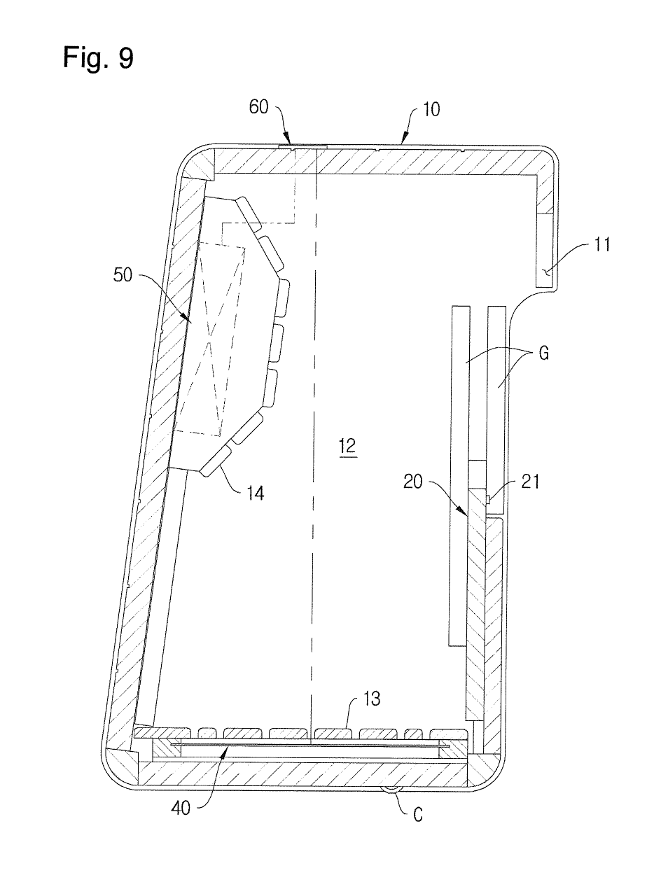

On the other hand, FIG. 8 is a perspective rear view showing a second embodiment of a knee sauna device 0 at the invention, and FIG. 9 is a side cross-sectional view along D-D in FIG. 8.

Referring to FIGS. 8 and 9, a knee sauna 0 at a second embodiment has substantially same overall structures as in the previously-described knee sauna 0 at the first embodiment, but it is different in that the top portion of the case (10) protrudes more toward the user's direction.

Here, it is worth to note that the top portion of the case (10) protrudes more toward the user's direction.

The knee sauna 0 at the first embodiment has a disadvantage that even though the top surface of the raising board (20) is contacted tightly to the user's thigh, since the heat can escape easily through the interval between the top portion of the case (10) and the thighs when the has thin thighs, the heat loss gets large.

Thus, since the protruding portion works as a duct and makes the heat pass the user's thighs maximally when the internal heat escapes to outside by making the top portion of the case (10) protrude more toward the user as in the second embodiment, the heat loss can be managed more efficiently, and furthermore since the thighs are heated the user may be able to feel as if he enjoys a half-body sauna.

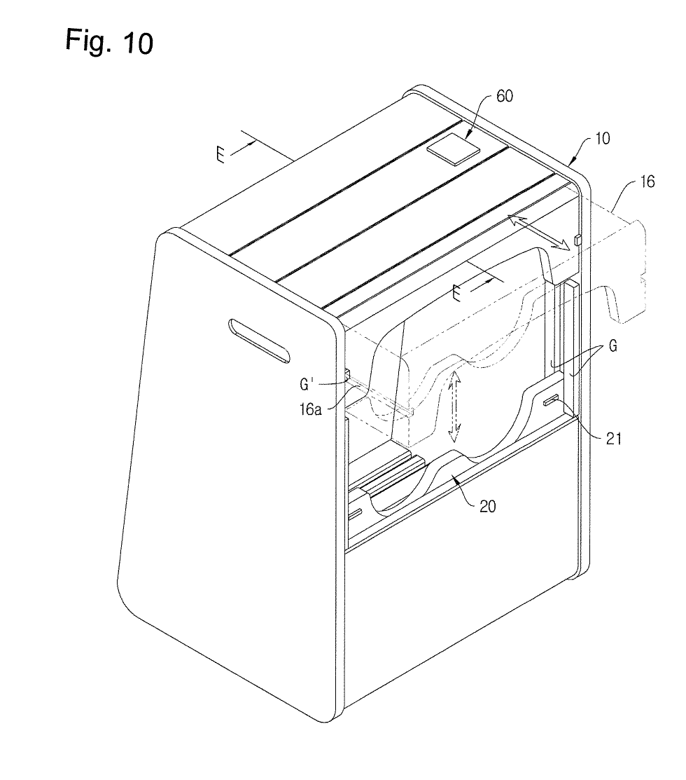

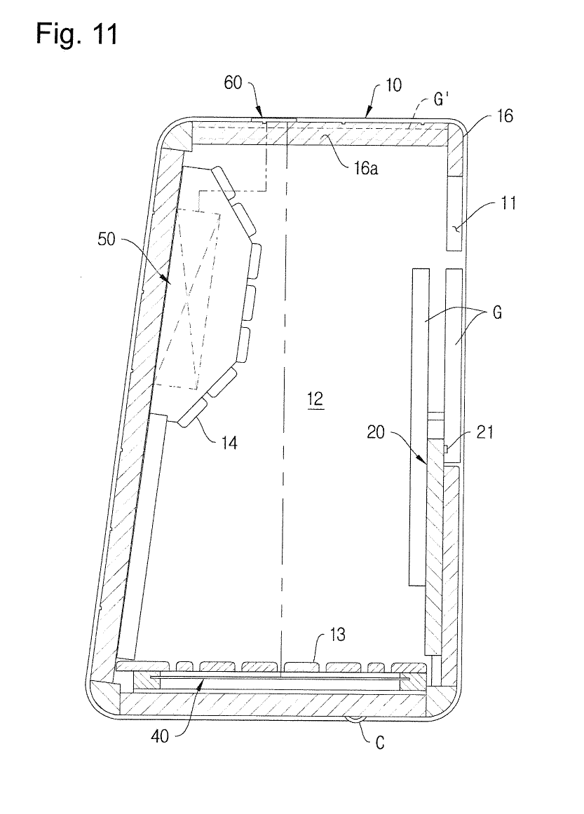

On the other hand, FIG. 10 is a perspective rear view showing a third embodiment of a knee sauna device 0 at the invention, and FIG. 11 is a side cross-sectional view along E-E in FIG. 10.

Referring to FIGS. 10 and 11, a knee sauna 0 at a third embodiment has substantially same overall structures as in the previously-described knee sauna 0 at the first and second embodiments, but it is different in that a length of the top portion of the case (10) can be adjusted in a sliding fashion.

Here, it is worth to note that a length of the top portion of the case (10) can be adjusted in a sliding fashion.

In the embodiment, on the internal top surface of the case (10) is installed a guide protrusion (G′), to which a box-type hextension board (16) having guide groove (16a) corresponding to the guide protrusion (G′) on both side surfaces is inserted slidingly.

For example, when a user with thin thighs uses the knee sauna 0 at the second embodiment, if the interval between the top portion of the case (10) and the thighs is large, the heat loss gets larger accordingly, so that the goals or functions that the knee sauna 0 at the second embodiment pursues cannot be achieved.

Therefore, 0 at the embodiment, the interval between the top portion of the case (10) and the thighs can be minimized by pulling the hextension board (16) toward the user and making the hextension board (16) contact tightly the top surface of the user's thighs maximally, and it can be used flexibly even to different conditions of the user's lower body condition (thick or thin thighs), and furthermore, since the protruding portion works as a duct when the internal heat escapes to outside after passing the user's thighs maximally it enables to manage the heat loss more efficiently, and further since the user can perform other works along with the sauna with a drink, a notebook, a book, etc. disposed in the extended surface, its usage is very convenient and useful.

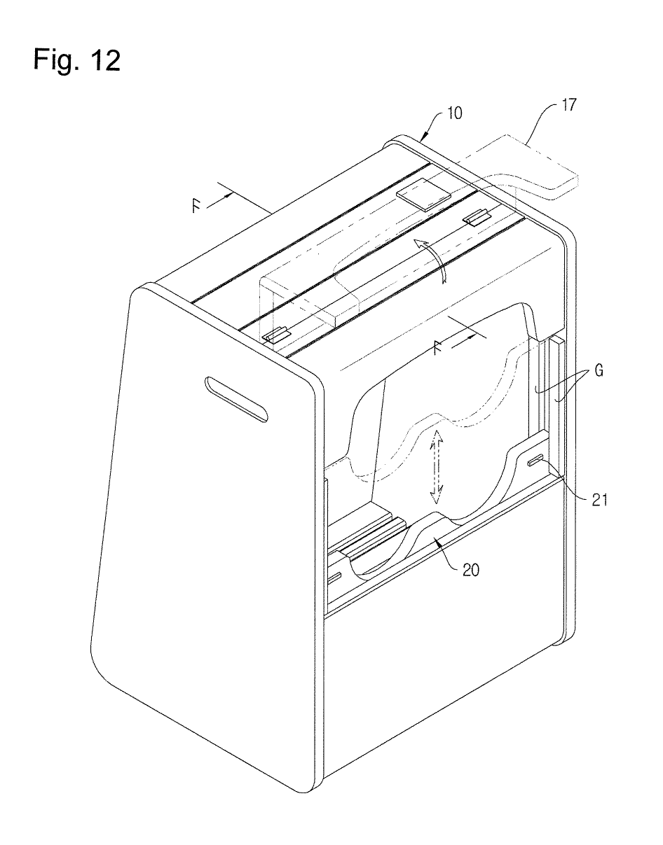

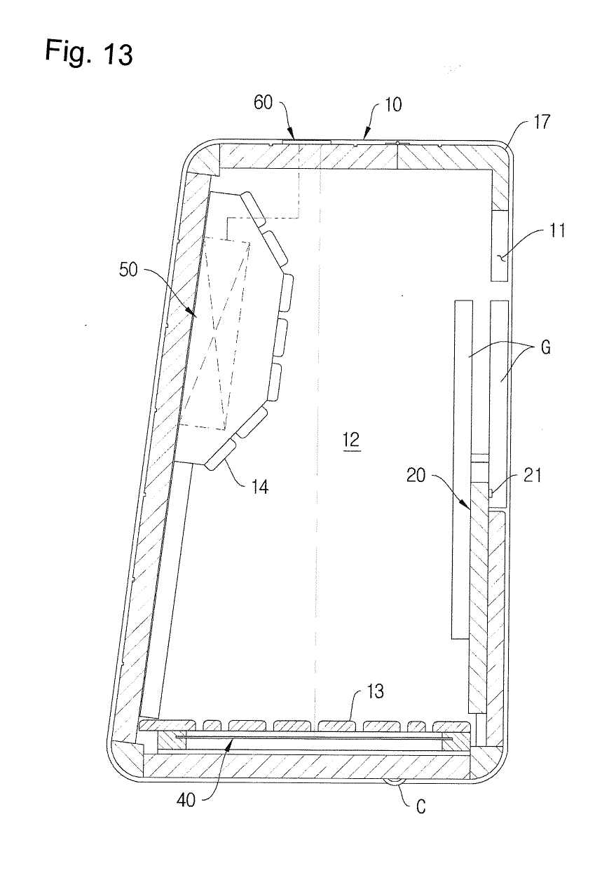

On the other hand, FIG. 12 is a perspective rear view showing a fourth embodiment of a knee sauna device 0 at the invention, and FIG. 13 is a side cross-sectional view along F-F in FIG. 12.

Referring to FIGS. 12 and 13, a knee sauna 0 at a fourth embodiment has substantially same overall structures as in the previously-described knee sauna 0 at the first embodiment, but it is different in that an L-shaped cover (17) is installed rotatably at an end of top portion of the case (10).

Here, it is worth to note that the L-shaped cover (17) is installed rotatably at an end of top portion of the case (10).

In this embodiment, the z17 was installed at an end of the top portion through a hinge while the top portion of the case (10) is formed short.

In the case of the knee sauna in the first embodiment, since the narrow opening portion (11) must be passed when the user has his lower body received or taken out of the inside of the case (10), it was somewhat inconvenient. Therefore, 0 at the embodiment, by rotating the z17 with respect to the hinge, the space of the opening portion (11) can be expanded much, and thus the user can have his lower body received or taken out much more conveniently.

In the embodiments, those 0 at the first and fourth embodiments only have been described referring to the drawings, but since, if necessary, a knee sauna can be fabricated by combining each embodiment selectively, interpretation limited to a part is not desirable.

While the invention has been shown and described with reference to different embodiments thereof, it will be appreciated by those skilled in the art that variations in form, detail, compositions and operation may be made without departing from the spirit and scope of the invention as defined by the accompanying claims.

Legend

| | |
|---|---|
| 10: Case | 11: opening portion |
| 12: receiving portion | 13: foot board |
| 14: heater cover | 16: extension board |
| 17: cover | 20: raising board |
| 30: stopper | 31: fixing device |
| 32: rail | 40: first heater |
| 50: second heater | 60: controller |

What is claimed is:

1. A knee sauna device comprising:
a case having an opening;
a raising board installed in the opening so as to be raised or lowered;
a stopper installed between the case and the raising board and configured for fixing the raising board;
a first heater installed on an internal floor surface of the case and configured for receiving electricity and generating heat; and
a second heater installed so as to protrude toward the opening from an internal top surface of the case and configured for receiving electricity and generating heat.

2. The knee sauna device of claim 1, wherein a top end portion of the case may protrude outside further.

3. The knee sauna device of claim 1, wherein an extension board is inserted slidably to a top side of the case.

4. The knee sauna device of claim 1, wherein an L-shaped cover is installed rotatably in a top end portion of the case.

5. The knee sauna device of claim 1, wherein the stopper comprises:
a fixing device including a body installed inside on a surface of the case that faces together with a side surface of the raising board, a ball received in the body, and a spring installed between the ball and the body and engaging elastically against a side surface of the raising board; and
a rail formed repeatedly in a direction of length and installed an a side surface of the raising board with fixing grooves in which the ball is being received.
